(19) United States
(12) Patent Application Publication
(10) Pub. No.: US 2009/0305037 A1
(43) Pub. Date: Dec. 10, 2009

(54) ELASTOMERIC SHEATH-CORE CONJUGATE FIBER

(75) Inventors: Shoichi Tsukada, Kyoto (JP); Hirofumi Yanagizawa, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: GUNZE LIMITED, Ayabe-shi, Kyoto (JP)

(21) Appl. No.: 12/067,095

(22) PCT Filed: Sep. 14, 2006
(86) PCT No.: PCT/JP2006/318301

§ 371 Date: Jul. 30, 2009

(30) Foreign Application Priority Data
Sep. 16, 2005 (JP) 2005-270916

(51) Int. Cl. B32B 27/36; D02G 3/00; B32B 27/40; B32B 27/34; B32B 27/02

(52) U.S. Cl. 428/395; 428/375; 428/394; 264/173.19

(57) ABSTRACT

The present invention provides a conjugate fiber having excellent elastic extensibility and transparency. The present invention relates to a highly elastic conjugate fiber comprising an elastomeric resin (A) having elastic extensibility; and an elastomeric resin (B) having elastic extensibility, permanent elongation of 25 to 70% and a tensile elongation of 100 to 800%; a core comprising the elastomeric resin (A), and a sheath comprising the elastomeric resin (B).

### TECHNICAL FIELD

The present invention relates to a material for producing stretchable clothing, such as stockings and panty stockings (PS).

### BACKGROUND ART

Stretch fibers have been widely used for pantyhose fibers. Examples of stretch fibers commonly used include single covered yarn (SCY), in which at least one nylon fiber is wound around a polyurethane fiber, and double covered yarn (DCY), in which nylon fibers are double-twisted around a polyurethane fiber in different directions (see, for example, Patent Documents 1 and 2). Crimped conjugate fibers prepared by bonding stretch fibers (polyurethane, etc.) and thermoplastic fibers (polyamide, etc.) successively in the length direction of the fiber are also used (see, for example, Patent Documents 3 to 7). Many improvements associated with these fibers in the elastic properties, strength, etc., of the desired clothing have been reported.

SCY and DCY generally have high supportability due to excellent elasticity; however, deficiencies include an increase in fabric thickness, low transparency, and increased production costs.

The crimped conjugate fibers described above have advantages such as low fabric thickness and high transparency compared with SCY and DCY; however, they generally have low supportability compared with SCY and DCY due to their crimpability, i.e., coiled stretching extensibility. Therefore, it was difficult to satisfy the demands (i.e., high supportability) of the current market with the crimped conjugate fibers.

Patent Document 1: Japanese Unexamined Patent Publication No. S47-19146
Patent Document 2: Japanese Unexamined Patent Publication No. S62-263339
Patent Document 3: Japanese Unexamined Patent Publication No. S61-34220
Patent Document 4: Japanese Unexamined Patent Publication No. S61-256719
Patent Document 5: Japanese Unexamined Patent Publication No. H03-206122
Patent Document 6: Japanese Unexamined Patent Publication No. H03-206124

### Patent Document 7: Japanese Unexamined Patent Publication No. 2003-171831

### DISCLOSURE OF THE INVENTION

### Problems to be Solved by the Invention

An object of the present invention is to provide a conjugate fiber having excellent elastic extensibility and transparency.

### Means for Solving the Problems

The present inventors conducted extensive research to accomplish the aforementioned object and found that a sheath-core conjugate fiber comprising two different kinds of stretch fibers has excellent crimpability and elasticity, while maintaining its transparency. The present invention was accomplished as a result of further research based on these findings.

To clarify, the present invention provides a conjugate fiber and a production process thereof, which is described below.

Item 1. A highly elastic conjugate fiber comprising an elastomeric resin (A) having elastic extensibility; and an elastomeric resin (B) having elastic extensibility, permanent elongation of 25 to 70% and a tensile elongation of 100 to 800%; a core comprising the elastomeric resin (A), and a sheath comprising the elastomeric resin (B).

Item 2. A conjugate fiber according to Item 1, wherein the core and the sheath of the conjugate fiber form an eccentric circle or a concentric circle.

Item 3. A conjugate fiber according to Item 1 or 2, wherein the elastomeric resin (A) is a polyurethane elastomer.

Item 4. A conjugate fiber according to any one of Items 1 to 3, wherein the elastomeric resin (B) is a polyester-based elastomer and/or polyamide-based elastomer.

Item 5. A conjugate fiber according to any one of Items 1 to 4, wherein the sheath further comprises a thermoplastic resin.

Item 6. A conjugate fiber according to any one of Items 1 to 5, wherein the sheath further comprises inorganic fine particles.

Item 7. Clothes made from the conjugate fiber according to any one of Items 1 to 6.

Item 8. A process for producing a conjugate fiber, comprising: melting each of an elastomeric resin (A) having elastic extensibility, and an elastomeric resin (B) having elastic extensibility, a permanent elongation of 25 to 70%, and a tensile elongation of 100 to 800%; conjugate spinning the resins with a spinneret having two conjugate nozzles such that the elastomeric resin (A) forms the core and the elastomeric resin (B) forms the sheath.

The present invention will be described in detail below.

### I. Conjugate Fiber

The conjugate fiber of the invention is an elastomeric sheath-core conjugate fiber comprising an elastomeric resin (A) having elastic extensibility, and an elastomeric resin (B) having elastic extensibility, a permanent elongation of 25 to 70% and a tensile elongation of 100 to 800%, wherein the core comprises the elastomeric resin (A), and the sheath comprises the elastomeric resin (B). The conjugate fiber of the present invention comprises the specific elastomeric resin (B) not only in the core but also in the sheath to increase the elastic extensibility of the fiber.

For example, when the cross section of the conjugate fiber is an eccentric circle type, the fiber exhibits elasticity due to its crimping strength at the beginning of stretching, and then exhibits the elastic extensibility of the elastomer to improve its supportability.

Any elastomeric resin (A) forming the core of the conjugate fiber of the invention with elastic extensibility can be used as long as the elastomeric resin (A) is a thermoplastic elastomer able to restore itself to near-original length even after stretching (no yield point in the stretchable range), i.e., exhibiting rubber elasticity (recovering to not more than 10% on a hysteresis curve). Examples of elastomeric resins (A) include polyurethane, polystyrene butadiene-based block copolymers, etc.; of these, polyurethane is particularly preferred.

The elastomeric resin (A) has a high tensile strength (JIS K7311) of about 30 to about 60 MPa, and preferably about 45 to about 60 MPa. The tensile elongation (JIS K7311) thereof is about 400 to about 900%, and preferably 400 to 600%.

Examples of elastomeric resin (A) include Kuramilon U (a product of Kuraray Co., Ltd.) 3195, 8175, etc. and Miractoran (a product of Nippon Polyurethane Industry Co., Ltd.) P485, P495, etc.

As an example of the production process of the elastomer resin (A), a polyurethane elastomer resin production process is described below. The polyurethane elastomer resin can be made, for example, from aromatic polyisocyantate and polyol, using known methods such as the one-shot method, the prepolymer method, etc.

Examples of aromatic polyisocyantates used as a raw material include aromatic diisocyanates having 6 to 20 carbon atoms (except carbons in an NCO group, same as above), modified products of such aromatic diisocyanates (modified diisocyanates having a carbodiimide group, a urethodione group, a urethoimine group, a urea group, etc.) and a mixture of two or more thereof.

Specific examples of aromatic polyisocyantates include 1,3- and/or 1,4-phenylenediisocyanate; 2,4- and/or 2,6-tolylene diisocyanate; 2,4′- and/or 4,4′-diphenylmethanediisocyanate (hereinafter abbreviated as MDI); 4,4′-diisocyanatobiphenyl; 3,3′-dimethyl-4,4′-diisocyanatodiphenylmethane; 1,5-naphthylene diisocyanate, etc. Of these, MDI is particularly preferred.

Examples of polyols used as a raw material include polyether-based polyols, polyester-based polyols, polycarbonate-based polyols, aliphatic-based polyols, etc. Polyether-based polyols or polyester-based polyols are particularly preferred.

The number average molecular weight of the polyol is preferably 300 or more, more preferably 1,000 or more, and most preferably 2,000 or more in terms of the softness of the fiber made from the material of the invention. The number average molecular weight of the polyol in terms of elasticity of the fiber is preferably 4,000 or less, more preferably 3,500 or less, and most preferably 3,000 or less.

The elastomeric resin (B) that constitutes the sheath of the conjugate fiber of the invention is a thermoplastic elastomer resin having elastic extensibility as well as a permanent elongation of 25 to 70%. A permanent elongation is defined in accordance with JIS K 6301. To clarify, when the resin (B) is stretched 100% or more, though it still has elastic extensibility, it is not restored to an original state but is instead restored to a stabilized state after stretching.

This is because in the original state of the elastomeric resin (B), the hard segment and the soft segment that constitute the elastomeric resin (B) are randomly distributed; however, when stretched 100% or more, the hard segment is oriented and cannot be restored to the original state, but the soft segment retains elastic extensibility. The conjugate fiber of the present invention takes full advantage of the elastomeric resin (B) described above to exhibit high supportability.

The permanent elongation (JIS K 6301) of the elastomeric resin (B) is about 25 to about 70%, preferably about 30 to about 70%, and more preferably about 40 to about 60% at 100% stretching. To get the permanent elongation, a dumbbell-shaped specimen is stretched under tensile load until the specified elongation reaches 100% (double-length), and then left to stand in that state for 10 minutes. Subsequently, the load is promptly released and the specimen is left to stand for ten minutes. The ratio of the elongation after being left alone for 10 minutes to the initial length is measured and defined as the permanent elongation (%). High supportability of the conjugate fiber cannot be obtained when the permanent elongation is less than 25%. When the permanent elongation exceeds 70%, the fiber becomes smaller due to the properties of the elastic body, and is plastic-deformed.

In general, the resin can further produce an elongation of about 100% (double-length) to about 300% (quadruple-length) from the permanent elongation.

The tensile strength (JIS K7311) of the elastomeric resin (B) is preferably about 10 to about 40 MPa, and more preferably a higher strength of about 25 to about 40 MPa. The tensile elongation (JIS K7311) is preferably about 100 to about 800%, and more preferably 400 to 600%. The resin having a tensile elongation of less than 100% is insufficiently stretchable and cannot be used for applications that require stretchability, while the resin having a tensile elongation of over 800% has low strength, resulting in low supportability.

Specific examples of the elastomeric resin (B) having the above-mentioned properties include urethane-based elastomers (TPU), polyester-based elastomers, polyamide-based elastomers, styrene-butadiene-based elastomers, etc. These elastomeric resins can be prepared using a known method, and a commercially available resin can be used as well.

Examples of urethane-based elastomers include a block copolymer comprising a soft segment containing a polyol component and a hard segment containing an organic polyisocyanate component. Specific examples thereof include polyester-based polyurethane elastomers, polycaprolactone-based polyurethane elastomers, polycarbonate-based polyurethane elastomers, polyether-based urethane-type elastomers, etc. For example, Kuramilon, manufactured by Kuraray Co., Ltd. can be exemplified.

Examples of polyester-based elastomers include a polyether (or polyester) ester block copolymer comprising a hard segment containing an aromatic polyester component, and a soft segment containing a polyether component or a polyester component. Examples of aromatic polyester components that are hard segments include polybutylene terephthalate (PBT), etc. Examples of polyether components or polyester components that are soft segments include polytetramethylene glycol (PTMG), polycaprolactone (PCL), etc. Any of these examples can be used in the present invention, though a polyether ester block copolymer is preferably used.

Specific examples thereof include Pelprene (P-type, S-type, etc.) manufactured by Toyobo Co., Ltd., and Hytrel manufactured by Du Pont Toray Co., Ltd. Further, polyester-based elastomers disclosed in Japanese Unexamined Patent Publication No. H11-302519 and Japanese Unexamined Patent Publication No. 2000-143954 can be used.

Examples of polyamide-based elastomers include a block copolymer comprising a hard segment containing a polyamide component, and a soft segment containing either or both a polyether component and a polyester component. Examples thereof include Pebax manufactured by Arkema Co., Ltd., the PAE series manufactured by Ube Industries, Ltd., etc.

Examples of styrene butadiene-based elastomer include a block copolymer comprising a hard segment containing a polystyrene component, and a soft segment containing a polyolefin component. Examples thereof include styrene-ethylene-butylene-styrene block copolymer (SEBS), etc.

In addition to eccentric circle-type and concentric circle-type sheath-core conjugate fibers, side by side-type sheath-core conjugate fibers can also be used for excellent crimpability by heat contraction, etc. Of these, the eccentric circle-type is preferred in terms of softness to the touch.

The share of the elastomeric resin (A) to a fiber cross section is about 30 to about 90%, preferably about 50 to about 70%. Within the range above, the conjugate fiber having high supportability can be obtained. At less than 30%, high supportability cannot be obtained since the elastomeric resin (B) occupies a high share of the fiber cross section, whereas at over 90%, the fiber cannot easily return to a stable state after stretching.

The diameter of the conjugate fiber of the invention is not particularly limited and is generally about 20 to about 100 μm, and preferably about 30 to 80 μm. In particular, when the fiber is used for panty stockings (PS), the diameter of about 40 to about 70 μm is preferred.

As described above, the elastomeric resin (A) that forms the core and has elastic extensibility has no yield point in the stretchable range (i.e., no elongation point over the elastic range); however, the elastomeric resin (B) has elastic extensibility and a yield point in its stretchable range. The conjugate fiber of the present invention inherits the property of the elastomeric resins. That is, when the conjugate fiber of the present invention is stretched beyond the yield point of the elastomeric resin (B), the elastomeric resin (B) is restored to the length of the yield point and stabilizes. In contrast, the elastomeric resin (A) remains in its elongated state, maintaining elastic extensibility. Thus, as a conjugate fiber, supportability is remarkably improved. This point is easily understood after referring to, for example, FIG. 1.

The conjugate fiber of the present invention has low thickness and high transparency when knitted to a clothing fabric.

Therefore, the conjugate fiber of the invention can be suitably utilized for stockings, pantyhose, and other clothing that requires the particular features described above. The use of the fiber is not limited thereto, and the fiber can be used for other clothing applications.

### II. Production Process of Conjugate Fiber

The conjugate fiber of the present invention can be prepared by melting each of the elastomeric resin (A) and the elastomeric resin (B), and conjugate spinning these resins with a spinneret having two conjugate nozzles such that the elastomeric resin (A) forms a core and elastomeric resin (B) forms a sheath. This process can be easily performed using a known spinning apparatus. Depending on its purpose, the fiber obtained can be elongated to adjust its strength and elongation.

The conjugate fiber of the present invention has excellent transparency and supportability, and is more easily manufactured than other known covered yarns. Therefore, production costs can be reduced, and high productivity is attained.

In order to also provide dyeing properties to a fiber, it is possible to alloy the dyeable resin (for example, nylon, polyester, etc.) with the elastomeric resin (B) of the sheath, thereby reforming the properties of the resin. Examples of dyeable resins that can be selected include polyamide-based, polyester-based, acryl-based, and vinylon-based resins, etc. Of these, polyamide-based and polyester-based resins are preferred. The mixing ratio thereof is determined in accordance with the dyeing property of the elastomer resin (B). The lower limit of the resin content is preferably 1 wt %; the upper limit of the resin content is preferably 30 wt %, and more preferably 10 wt %. At less than 1 wt %, the fiber exhibits low color enhancement after dyeing, whereas at over 30 wt %, the strength and elongation of the fiber may be lowered. Further, spinning property is impaired.

Examples of the production process thereof include mixing the resin described above with the elastomeric resin (B), and supplying the result to an extruder. It is desirable that the resins be dispersed uniformly in order to obtain a stabilized property; therefore, it is preferable that the compound raw material be prepared using a biaxial kneading machine, and the resultant supplied into the extruder.

By the above methods, high-fashion pantyhose that are very soft to the touch and can be dyed in various ways can be prepared.

In the conjugate fiber of the present invention, the softness to the touch can be improved by dispersing inorganic fine particles and the like on the surface of the elastomeric resin (B) of the sheath.

Inorganic fine particles are not particularly limited. Examples thereof include light calcium carbonate, ground calcium carbonate and like calcium carbonates; barium carbonate; basic magnesium carbonate and like magnesium carbonates; kaolin, talc, calcium sulfate, barium sulfate, titanium dioxide, titanium oxide, zinc oxide, magnesium oxide, ferrite powder, zinc sulfide, zinc carbonate, satin white, calcinated diatomaceous earth, and like diatomaceous earth; calcium silicate, aluminum silicate, magnesium silicate, amorphous silica, non-crystalline synthetic silica, colloidal silica and like silica; colloidal alumina, pseudo-boehmite, aluminium hydroxide, magnesium hydroxide, alumina, lithopone, zeolite, aluminosilicate, activated clay, bentonite, sericite, and like mineral pigments. These may be used singly or in combination. Of these, titanium oxide, zinc oxide, barium sulfate, and silica are preferred.

There is no specific limitation on the shape of the inorganic fine particles, and examples thereof include regular shape particles such as ball-like, needle-like, and plate-like particles, or irregular shape particles.

The above-mentioned inorganic fine particles preferably have an average particle diameter of 0.2 μm minimum and 3 μm maximum. Particles with an average particle diameter of less than 0.2 μm are insufficient for decreasing the discomfort of stickiness, etc. in humid weather. When inorganic fine particles with an average particle diameter greater than 3 μm are used for producing clothing, the texture and softness may be impaired, and the strength of the fiber may be reduced.

The lower limit of the inorganic fine particles content is preferably 2 wt %. The upper limit of the inorganic fine particles content is preferably 30 wt %, and more preferably 7 wt %. At less than 2 wt %, the effect of decreasing the discomfort of stickiness, etc., in humid weather may not be fully attained, whereas at over 30 wt %, the strength and elongation of the fiber may be lowered. Further, spinning property is also lowered.

Examples of the production process thereof include mixing the inorganic fine particles with the elastomeric resin (B), and supplying the resulting mixture into an extruder. However, it is desirable that the resins be dispersed uniformly in order to obtain a stabilized property; therefore, it is preferable that the compound raw material be prepared using a biaxial kneading machine, and the resultant thereafter supplied into the extruder.

### EFFECTS OF THE INVENTION

The conjugate fiber of the present invention has characteristics such as decreased fabric thickness, high transparency, and high supportability due to high stretchability, which could not be attained by the known SCY, DCY and conjugate fibers comprising stretch fibers and thermoplastic fibers.

The conjugate fiber of the present invention has excellent elastic extensibility and transparency, and is thus suitable to be used as material in stylish, stretchable clothing of high supportability, especially in stockings and pantyhose.

### BRIEF DESCRIPTION OF THE DRAWINGS

FIG. 1 is a schematic view showing the elastic behavior of the conjugate fiber of the invention. Elastomeric resin (A) returns to approximately its original length after being stretched. In other words, it is elastic within its elongation at yield point (e.g., polyurethane). Elastomeric resin (B) is stretched beyond its elongation at yield point and returns to the elongation at yield point after being stretched (e.g., polyester elastomer). The conjugate fiber of the invention is stretched beyond the elongation at yield point of the elastomeric resin (B) in the sheath and returns to the elongation at yield point after being stretched. Also, in the elongation at yield point, the elastomeric resin (A) in the core holds elastic extensibility.

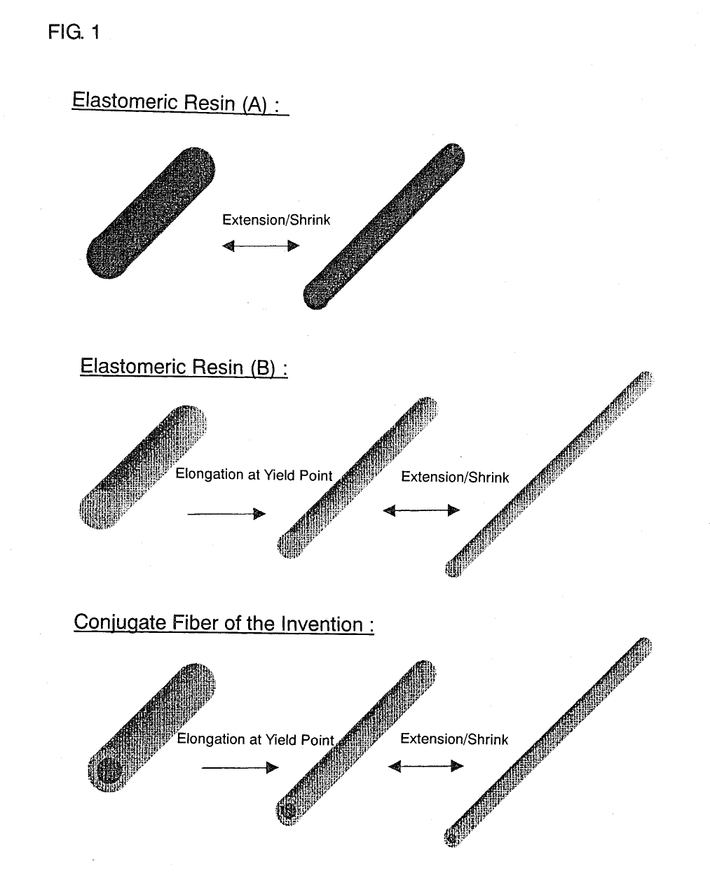

FIG. 2 is a micrograph of the cross-section of the conjugate fiber of the invention.

FIG. 3 is a schematic view of an evaluation method of transparency.

### BEST MODE FOR CARRYING OUT THE INVENTION

The invention will be described in more detail below by way of Examples and Comparative Examples, which are not intended to limit the invention.

### Example 1

Thermoplastic polyurethane and polyester-based elastomer were separately melted at 200° C. and 195 to 210° C., respectively, and were conjugate spun with a spinneret having two conjugate nozzles, which was heated at 195° C., to obtain a non-crimp developing type (concentric type) bicomponent fiber in which the thermoplastic polyurethane formed the core and the polyester-based elastomer formed the sheath. The area ratio of the thermoplastic polyurethane to the polyester-based elastomer in the cross section of the bicomponent fiber was changed depending on the ratio of each component discharged by a gear pump.

The amount of discharge was adjusted so that the fiber becomes a single yarn having 24 d after being stretched.

The yarn was wound up in an unstretched state at a spinning rate of 500 m/minute, with the addition of a silicon-based oil solution. Then, the yarn was stretched in another step and aged at 80° C. for 24 hours under an air atmosphere with a dewpoint temperature of 10° C.

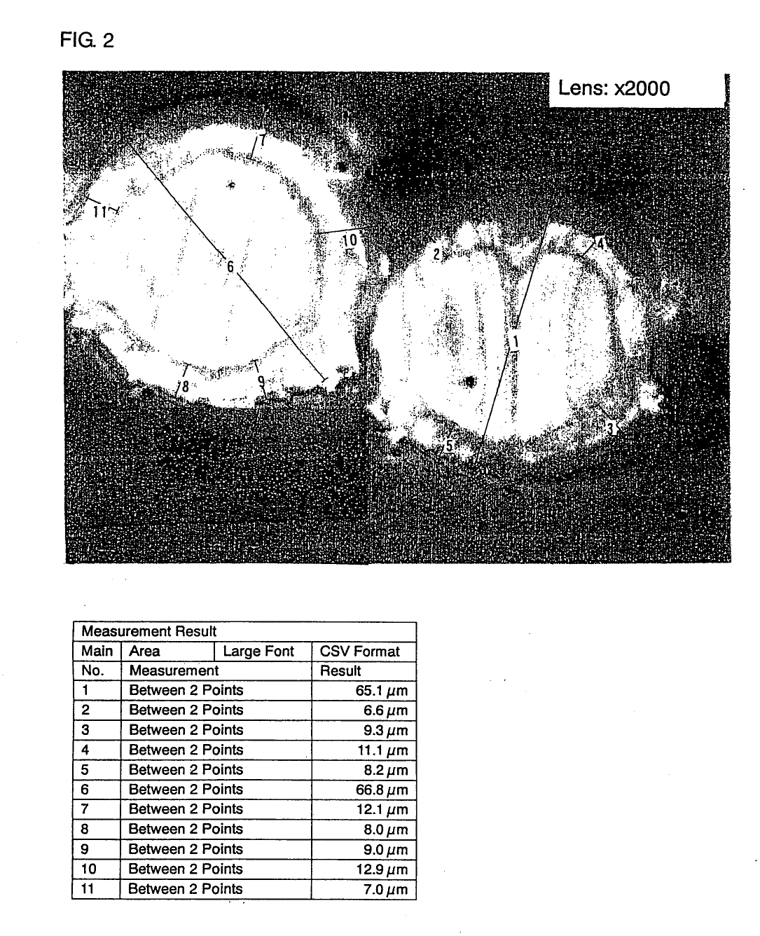

The cross-sectional photograph of the obtained conjugate fiber is shown in FIG. 2. The diameter of the fiber was 61 μm and the core accounted for 58% of the sectional area of the fiber.

### Comparative Example 1

A conjugate fiber was produced in a similar manner as in Example 1 except for using a polyamide (nylon-6) in place of the polyester-based elastomer in Example 1.

The diameter of the fiber was 60 μm and the core accounted for 56% of the sectional area of the fiber.

### Comparative Example 2

A single covered yarn containing a polyurethane elastic yarn measuring 22 dT as a core yarn and a nylon yarn measuring 11 dT/5 filaments as a covering yarn twisted around the polyurethane elastic yarn in the S direction was produced.

### Example 2

Using the conjugate fiber of Example 1, a cylindrical knitting fabric was knitted in a single knitting pattern (plain knitting pattern) on a single cylinder knitting machine, and the toe ends and the panty part thereof were stitched in accordance with a standard process. Then, the fabric was dyed (beige; carlo) and heat-set on a foot mold, thereby producing pantyhose.

### Comparative Example 3

Using the conjugate fiber of Comparative Example 1, pantyhose were produced in the same manner as in Example 2.

### Comparative Example 4

Using the single covered yarn of Comparative Example 2, pantyhose were produced in the same manner as in Example 2.

### Test Example 1

The fibers obtained in Example 1 and Comparative Examples 1 and 2, and the fabrics obtained in Example 2 and Comparative Examples 3 and 4 were evaluated in the following manner.

### [Evaluation of Surface Properties]

Surface properties of the pantyhose fabric (MIU: coefficient of dynamic friction, MMD: fluctuation range of coefficient of dynamic friction, unit: dimensionless; and SMD: surface roughness, unit: μm) were measured using a KES system (manufactured by Kato Tech Co., Ltd.).

### [Evaluation of Elastic Extensibility]

Elastic extensibility of the pantyhose fabric was evaluated by measuring the recovery stress after being stretched to a constant length (lateral stretch). A stretching jig was attached to a 10 cm portion of an inseam (knee region), and the recovery stress was measured at 50 cm extension, a maximum of 60 cm extension, and 50 cm recovery (unit: CN).

### [Evaluation of Transparency]

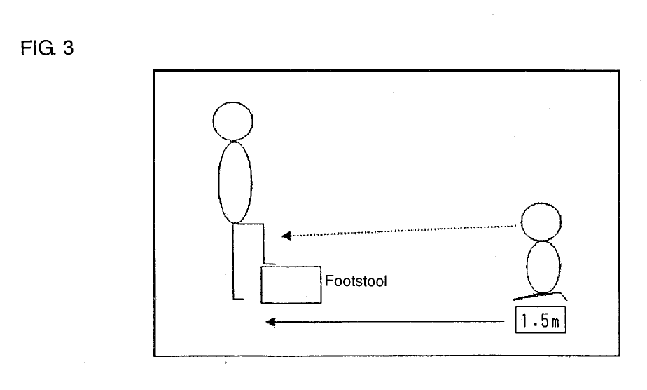

Transparency of the pantyhose fabric was evaluated by sensory evaluation. Specifically, as shown in FIG. 3, a subject wears each of the pantyhose and puts one leg on a footstool. Evaluators sit on the floor 1.5 meters away from the subject to evaluate the pantyhose. Evaluation items are “transparency”, “no sheen (glareless)”, and “a natural, bare-legged appearance”. One wearer was evaluated by nine evaluators. The evaluation scale includes 5 levels in total: a normal level (0) as the middle level and 2 anteroposterior levels from the normal level (−2, −1, where the negative numeral indicates an inferior evaluation; and +1, +2, where the positive numeral indicates a superior evaluation). The average values (to one decimal place) of each evaluated item were calculated.

### Color Value

The color difference fomulas (L*, a*, b*) and the optical density of 16 stacked pieces of pantyhose fabric were measured using a WHITE EYE3000 Macbeth spectrophotometer (manufactured by Kollmongen Instruments Corporation). The optical density is the opacity index, which shows that transparency is higher at a lower numerical value.

Results of the above measurements are shown in Tables 1 and 2.

TABLE 1

| | Measurement Item | |
|---|---|---|
| | | Elastic Extensibility: Knee |
| | Values of the Surface | Area (at 50 cm. extension, |
| | Measurement | maximum 60 cm. extension, |
| | (MIU, MMD, SMD) | 50 cm. recovery) |
| Example 1 | 0.240, 0.0111, 3.056 | 383.9, 813.9, 123.3 |
| Comparative | 0.209, 0.0129, 5.063 | 306.2, 514.5, 115.8 |
| Example 1 | | |
| Comparative | 0.225, 0.0407, 2.875 | 567.9, 872.0, 288.9 |
| Example 2 | | |

TABLE 2

| | Measurement item | |
|---|---|---|
| | Transparent Properties | |
| | (Transparency, No Sheen, | Color Value |
| | Natural, Bare-Legged | (L*, a*, b*, Optical |
| | Appearance) | Density) |
| Example 2 | 1.0, 0.8, 1.2 | 52.71, 10.90, 19.01, 28.6 |
| Comparative | 0.9, 0.4, 1.0 | 48.96, 8.45, 15.83, 35.1 |
| Example 3 | | |
| Comparative | −0.4, 0.6, −0.7 | 48.05, 8.00, 18.02, 38.5 |
| Example 4 | | |

The above results show that the pantyhose fabric of Example 1 has both a narrow fluctuation range of the dynamic friction coefficient and a small asperity as a result of MMD and SMD, which means that the fabric is less scratchy. Further, the fabric is superior in elastic extensibility to Comparative Example 1. Moreover, the evaluation of the transparency indicated that the fabric had high transparency and less sheen, and gave the legs a natural, bare-legged appearance. This result was also supported by the low optical density of the color value.

Therefore, the conjugate fiber of the present invention has overall excellent elastic extensibility and transparency, and is suitably used as material for stretchable garments such as pantyhose.

1. A highly elastic conjugate fiber comprising an elastomeric resin (A) having elastic extensibility; and an elastomeric resin (B) having elastic extensibility, permanent elongation of 25 to 70% and a tensile elongation of 100 to 800%; a core comprising the elastomeric resin (A), and a sheath comprising the elastomeric resin (B).

2. A conjugate fiber according to claim 1, wherein the core and the sheath of the conjugate fiber form an eccentric circle or a concentric circle.

3. A conjugate fiber according to claim 1, wherein the elastomeric resin (A) is a polyurethane elastomer.

4. A conjugate fiber according to claim 1, wherein the elastomeric resin (B) is a polyester-based elastomer and/or polyamide-based elastomer.

5. A conjugate fiber according to claim 1, wherein the sheath further comprises a thermoplastic resin.

6. A conjugate fiber according to claim 1, wherein the sheath further comprises inorganic fine particles.

7. Clothes made from the conjugate fiber according to claim 1.

8. A process for producing a conjugate fiber, comprising: melting each of an elastomeric resin (A) having elastic extensibility, and an elastomeric resin (B) having elastic extensibility, a permanent elongation of 25 to 70%, and a tensile elongation of 100 to 800%; conjugate spinning the resins with a spinneret having two conjugate nozzles such that the elastomeric resin (A) forms the core and the elastomeric resin (B) forms the sheath.
